(19) United States
(12) Patent Application Publication
(10) Pub. No.: US 2011/0065391 A1
(43) Pub. Date: Mar. 17, 2011

(54) WIRELESS COMMUNICATION APPARATUS FOR CHANGING DIRECTIONAL PATTERN OF VARIABLE DIRECTIVITY ANTENNA ACCORDING TO VARIATIONS IN RADIO WAVE PROPAGATION ENVIROMENT

(76) Inventors: Akihiko Shiotsuki, Osaka (JP); Sotaro Shinkai, Osaka (JP); Masahiko Nagoshi, Osaka (JP); Hiroyuki Yurugi, Osaka (JP); Wataru Noguchi, Hyogo (JP); Koichiro Tanaka, Hyogo (JP)

(21) Appl. No.: 12/993,980

(22) PCT Filed: May 27, 2009
(86) PCT No.: PCT/JP2009/002339

§ 371 Date: Nov. 22, 2010

(30) Foreign Application Priority Data
May 27, 2008 (JP) 2008-137618

(51) Int. Cl. H04B 15/00; H04B 1/00

(52) U.S. Cl. 455/63.4; 455/115.1; 455/115.3

(57) ABSTRACT

When a variable directivity antenna apparatus is controlled to form an initial composite directional pattern, RSSI is measured, and a weak electric field group or an intense electric field group is selected based on the measured RSSI. When the variable directivity antenna apparatus is controlled to form the composite directional patterns included in the selected composite directional pattern group, PER for each of the composite directional patterns is measured, and one composite directional pattern is selected from among the composite directional patterns included in the selected composite directional pattern group based on the measured PER, so that the variable directivity antenna apparatus is controlled to form the selected composite directional pattern.

### TECHNICAL FIELD

The present invention relates to a wireless communication apparatus. In particular, the present invention relates to a wireless communication apparatus which changes a directional pattern of a variable directivity antenna thereof according to variations in a radio wave propagation environment.

### BACKGROUND ART

Among network configurations in which information terminals are connected to each other, a network that uses wireless communication has such advantages as superiority in portability of the information terminals, freedom in the arrangement of the information terminals, and reduction of the weight of the information terminals by removing cables for connections between the information terminals, as compared with a network that uses wire communication. For the above reasons, wireless communication apparatuses have been not only utilized for data transmissions between personal computers but also built in many home electric appliances and utilized for audio and visual data transmissions between the home electric appliances.

The wireless communication apparatus has the above-described advantages, however, when installed in a space where a number of reflective objects are placed, the wireless communication apparatus sometimes fails to correctly transmit data because of deteriorations in transmission performance due to the influence of fading caused by delayed waves incoming after reflected by the objects, since the wireless communication apparatus perform communications by emitting electromagnetic waves in the space. Conventionally, as measures against the fading, there have been proposed control methods such as directivity control of transceiving antenna and various diversity processing. For example, the Patent Documents 1 to 3 disclose wireless communication apparatuses according to prior art for receiving wireless signals considering variations in the radio wave propagation environment with time.

In the antenna directivity control system described in the Patent Document 1, a receiver apparatus wirelessly receives a measurement signal for requesting a radio wave propagation delay time from a transmitter apparatus while controlling so that a beam width of a composite directivity of antenna elements included in a variable directivity receiving antenna becomes the widest. Further, the receiver apparatus separates a received measurement signal into a direct wave and delayed waves, measure delay times between a separated direct wave and respective delayed wave components, calculate a width of a distribution of the delay times of the respective delayed wave components, and controls the directivity pattern of the variable directivity receiving antenna to decrease the receiver sensitivity in the direction from which the delayed waves income based on the calculation results. By this operation, it is possible to communicate in the environment in which numbers of delayed waves exist by reducing the influence of the delayed waves.

In addition, the antenna selecting diversity apparatus described in the Patent Document 2 includes a plurality of antennas, and an antenna information storing section stores data on priorities for selection an antenna from among the plurality of antennas. The antenna selecting section controls an antenna selecting switch to select a standby antenna other than the antenna currently in use one time every several frames in a steady state when the communication is performed using a specific antenna as the antenna currently in use. A selected standby antenna becomes a measuring antenna. Each of the standby antennas is selected sequentially as the measuring antenna according to the data on priorities stored in the antenna information storing section. When such a state that a receiving level at the antenna currently in use is smaller than a receiving level at the measuring antenna occurs several times successively, the antenna selecting section controls the antenna selecting switch to select the measuring antenna as a newly selected antenna currently in use. Otherwise, similar processing is executed repeatedly by using a standby antenna having a lower priority as the measuring antenna. By this operation, it becomes possible to select for a short time an antenna optimum to the propagation environment in which the communication is performed.

Further, the antenna selecting diversity apparatus described in the Patent Document 3 selects an optimum antenna apparatus based on signals received at a plurality of diversity branches each having an antenna, a detector and a correlation detector, differently from the antenna selecting diversity apparatus described in the Patent Document 2. Each of the correlation detectors previously stores known patterns of a frame synchronization signal from the transmitter. In addition, each of the correlation detectors outputs correlation coefficient between the signal received at the antenna and the known pattern of the frame synchronization signal severally to a signal processor. The signal processor selects a diversity branch having a maximum correlation coefficient. By this operation, it is possible to overcome the multipath fading and prevent deteriorations in throughput from occurring by adding simple hardware to the conventional antenna selecting diversity apparatus.

### CITATION LIST

### Patent Document

Patent Document 1: Japanese patent laid-open publication No. JP-2000-134023-A.

Patent Document 2: Japanese patent laid-open publication No. JP-2005-142866-A.

Patent Document 3: Japanese patent laid-open publication No. JP-8-172423-A.

### SUMMARY OF INVENTION

### Technical Problem

In the antenna directivity control system described in the Patent Document 1, the transmitter apparatus periodically transmits the measurement signal to the receiver apparatus in order to control the directional pattern of the antenna to reduce the influence of the delayed waves. Therefore, when the variations in the radio wave propagation environment with time are large, it is required to transmit the measurement signal frequently in order to follow the variations, and this leads to an increase in the data amount of control data other than the data to be transmitted and received. Consequently, the deterioration in the throughput will occur.

In addition, in the antenna selecting diversity apparatus described in the Patent Document 2, the measurement signal of the Patent Document 1 is not transmitted, however, it is required to obtain the receiving level by periodically switching over to another standby antenna and communicating with the another standby antenna even in the steady state when the antenna currently in use is determined. Therefore, it is required to perform needless antenna control, and this leads to deteriorated throughput.

In portable wireless terminal equipment that transmits and receives wide-band wireless signals such as a fourth generation portable telephone or portable wireless terminal equipment for receiving a digital television broadcasting signal, a high signal quality is required, and therefore, it is effective to use a MIMO (Multiple-Input Multiple-Output) communication system. The MIMO communication system is a technology to increase transmission capacity by spatially multiplexing a plurality of signal sequences simultaneously transmitted within the same frequency band using a plurality of antenna elements in each of the transmitter and the receiver, and to increase the total transmission rate for a plurality of signal sequences after MIMO (Multiple-Input Multiple-Output) decoding. However, when the antenna selecting diversity apparatus described in the Patent Document 2 or the Patent Document 3 is used for the MIMO communication system, there is such a problem that a plurality of antenna selecting diversity apparatuses should be provided in the receiver apparatus, and this leads to an increased size of the receiver apparatus.

It is an object of the present invention to provide a wireless communication apparatus capable of solving the above problems, and capable of transmitting and receiving data signals at higher speed and more stably than in the prior art even when the radio wave propagation environment changes.

### Solution to Problem

A wireless communication apparatus according to the present invention includes a variable directivity antenna apparatus, a storage device and controller. The variable directivity antenna apparatus includes at least one variable directivity antenna element, and forms a plurality of composite directional patterns each of which is a superposition of respective directional patterns of the at least one variable directivity antenna element. The storage device previously stores therein composite directional pattern classification information on classification of the plurality of composite directional patterns into a plurality of composite directional pattern groups set by using a first parameter representing a quality level of a wireless signal received by the variable directivity antenna apparatus. The controller selects one composite directional pattern from among the plurality of composite directional patterns based on the first parameter and a second parameter, and controls the composite directional pattern of the variable directivity antenna apparatus so that the variable directivity antenna apparatus forms a selected composite directional pattern, where the second parameter represents the quality level of the wireless signal and is different from the first parameter.

In the above-described wireless communication apparatus, (a) when the controller controls the variable directivity antenna apparatus to form one predetermined composite directional pattern among the plurality of composite directional patterns, the controller measures the first parameter, and selects one composite directional pattern group from among the plurality of composite directional pattern groups with reference to the composite directional pattern classification information based on a measured first parameter. (b) When the controller controls the variable directivity antenna apparatus to form composite directional patterns included in a selected composite directional pattern group, the controller measures second parameters for the composite directional patterns included in the selected composite directional pattern group, respectively, and selects one composite directional pattern from among the composite directional patterns included in the selected composite directional pattern group based on respective measured second parameters. (c) The controller controls the variable directivity antenna apparatus to form a selected composite directional pattern.

In addition, in the above-described wireless communication apparatus, the controller measures a third parameter representing the quality level of the wireless signal when the controller controls the variable directivity antenna apparatus to form the selected composite directional pattern, judges whether or not a measured third parameter is equal to or smaller than a predetermined first threshold value, and controls the variable directivity antenna apparatus to form a further composite directional pattern other than the selected composite directional pattern upon detecting that the measured third parameter is equal to or smaller than the first threshold value.

Further, in the above-described wireless communication apparatus, the controller controls the variable directivity antenna apparatus to form the further composite directional pattern other than the selected composite directional pattern upon detecting that the measured third parameter is equal to or smaller than the first threshold value a predetermined threshold times successively.

Still further, in the above-described wireless communication apparatus, the controller measures the first parameter when the controller controls the variable directivity antenna apparatus to form the selected composite directional pattern, calculates a reference first parameter based on the first parameter measured immediately after starting the control, and calculates a last first parameter based on the first parameter measured immediately before the detection. The controller selects the further composite directional pattern from among all of the plurality of composite directional patterns when a magnitude of a difference between a calculated reference first parameter and the last first parameter is equal to or larger than a predetermined second threshold value, and selects the further composite directional pattern from among the composite directional patterns other than the selected composite directional patter and included in the selected composite directional pattern group when the magnitude of the difference between the calculated reference first parameter and the last first parameter is smaller than the predetermined second threshold value.

In addition, in the above-described wireless communication apparatus, the third parameter is the same as the second parameter.

Further, in the above-described wireless communication apparatus, the predetermined one composite directional pattern is substantially omnidirectional.

Still further, in the above-described wireless communication apparatus, the first parameter represents a received signal level of the wireless signal.

In addition, in the above-described wireless communication apparatus, for each of the composite directional patterns, the composite directional pattern classification information includes data on the directional patterns of the respective variable directivity antenna elements and data on the directional pattern group which is selected from among the plurality of composite directional pattern groups and in which the composite directional pattern is included.

### ADVANTAGEOUS EFFECTS OF INVENTION

The wireless communication apparatus according to the present invention has the storage device and the controller. The storage device previously stores composite directional pattern classification information on classification of the plurality of composite directional patterns into a plurality of composite directional pattern groups set by using a first parameter representing a quality level of a wireless signal received by the variable directivity antenna apparatus. The controller selects one composite directional pattern from among the plurality of composite directional patterns based on the first parameter and a second parameter, and controls the composite directional pattern of the variable directivity antenna apparatus so that the variable directivity antenna apparatus forms a selected composite directional pattern, where the second parameter represents the quality level of the wireless signal and is different from the first parameter. Therefore, even when the radio wave propagation environment changes, the data signal can be transmitted and received at higher speed and more stably than in the prior art.

### BRIEF DESCRIPTION OF DRAWINGS

FIG. 1 is a block diagram showing a configuration of a wireless communication apparatus 1 according to a first preferred embodiment of the present invention;

FIG. 2 is a chart showing one example of a composite directional pattern table stored in a composite directional pattern table memory 2m of FIG. 1;

FIG. 3 is a chart showing one example of composite directional patterns Pa to Pf of the composite directional pattern table of FIG. 2;

FIG. 4 is a flow chart showing a directional pattern control process executed by a controller 2 of FIG. 1;

FIG. 5 is a flow chart showing a composite directional pattern group selecting process S2 of FIG. 4;

FIG. 6 is a flow chart showing a composite directional pattern selecting process S4 of FIG. 4;

FIG. 7 is a flow chart showing a reference RSSI (RSSIr) calculating process S7 of FIG. 4;

FIG. 8 is a flow chart showing a composite directional pattern selecting process S4A according to a first modified preferred embodiment of the first preferred embodiment of the present invention;

FIG. 9 is a flow chart showing a composite directional pattern selecting process S4B according to a second modified preferred embodiment of the first preferred embodiment of the present invention;

FIG. 10 is a flow chart showing a composite directional pattern selecting process S4C according to a third modified preferred embodiment of the first preferred embodiment of the present invention;

FIG. 11 is a flow chart showing a directional pattern control process according to a second preferred embodiment of the present invention;

FIG. 12 is a conceptual diagram showing composite directional pattern classification information stored in the composite directional pattern table memory 2m in a first modified preferred embodiment of the second preferred embodiment of the present invention;

FIG. 13 is a conceptual diagram showing the composite directional pattern classification information stored in the composite directional pattern table memory 2m in a third preferred embodiment of the present invention;

FIG. 14 is a first part of a flow chart showing the directional pattern control process of the third preferred embodiment of the present invention; and

FIG. 15 is a second part of the flow chart showing the directional pattern control process of the third preferred embodiment of the present invention.

### DESCRIPTION OF EMBODIMENTS

Preferred embodiments according to the present invention will be described below with reference to the attached drawings. Components similar to each other are denoted by the same reference numerals and will not be described herein in detail.

### First Preferred Embodiment

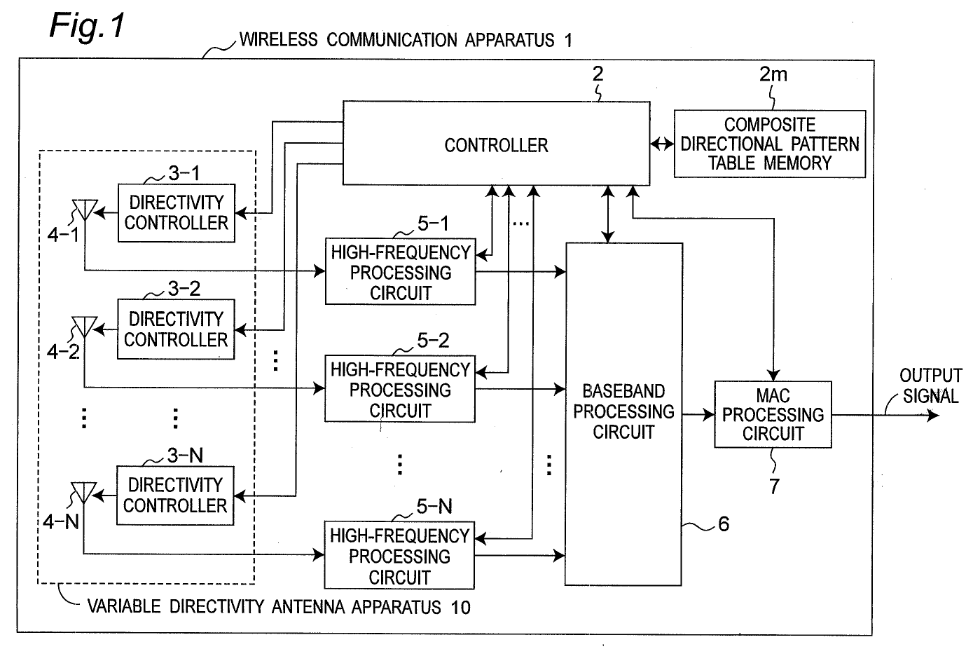

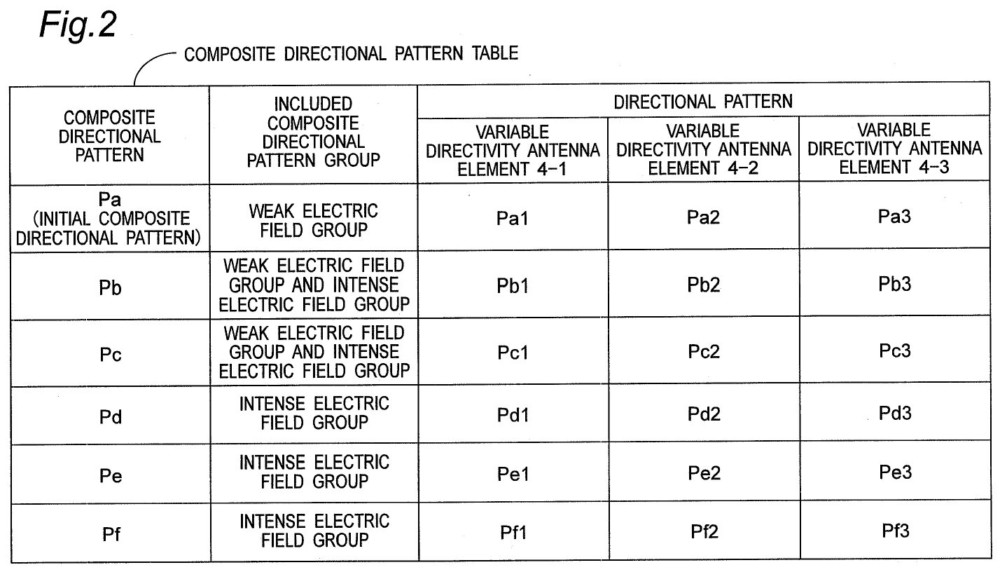

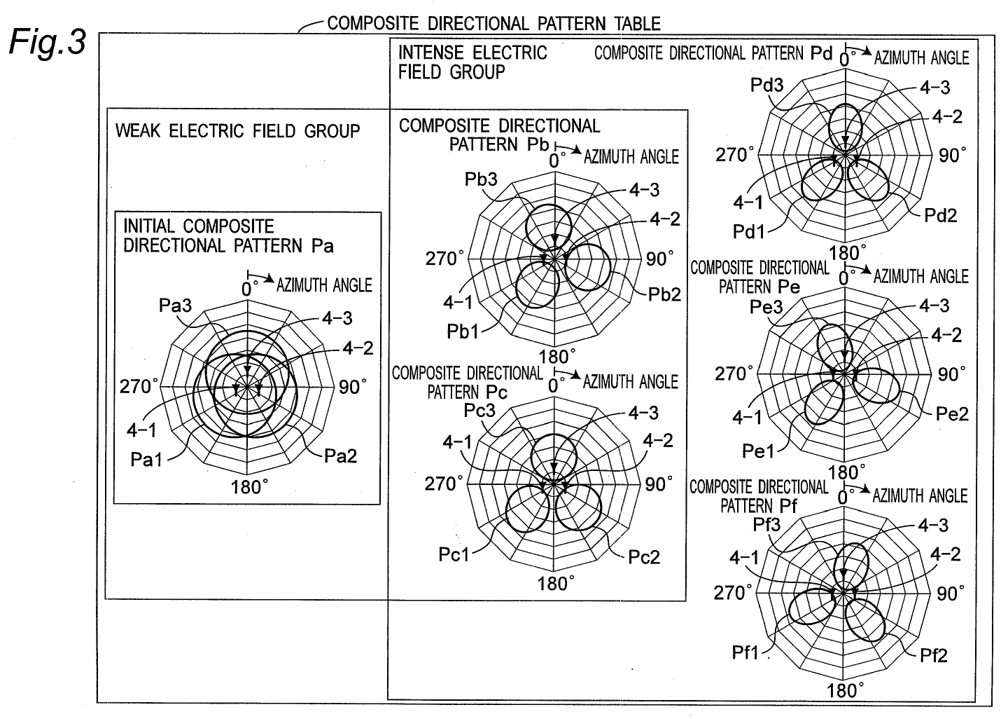

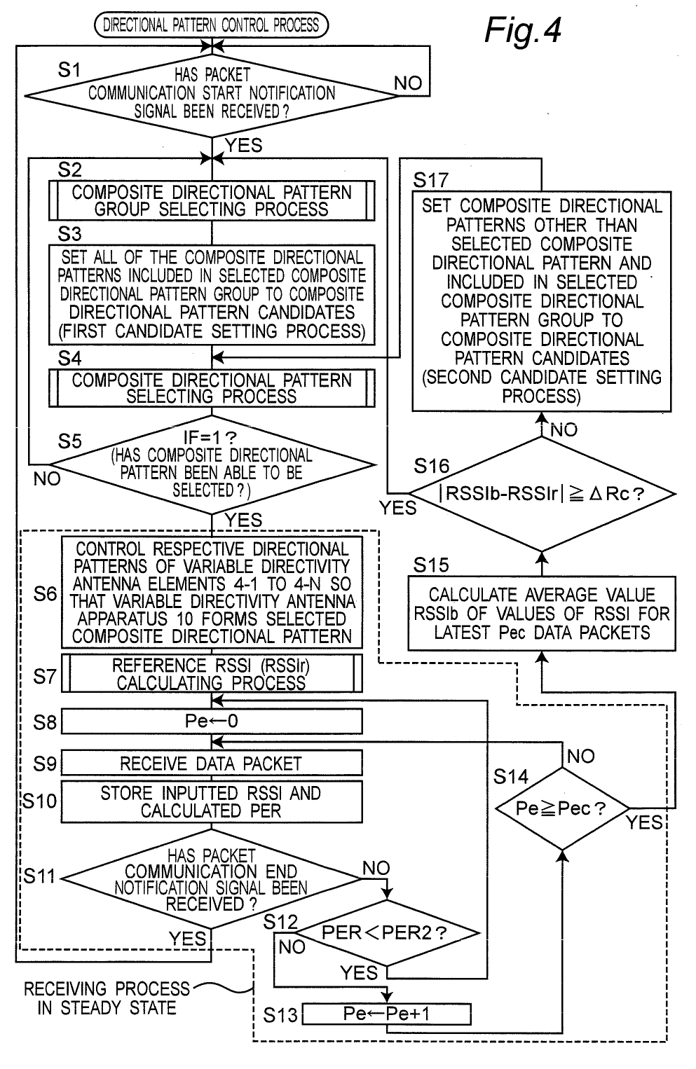

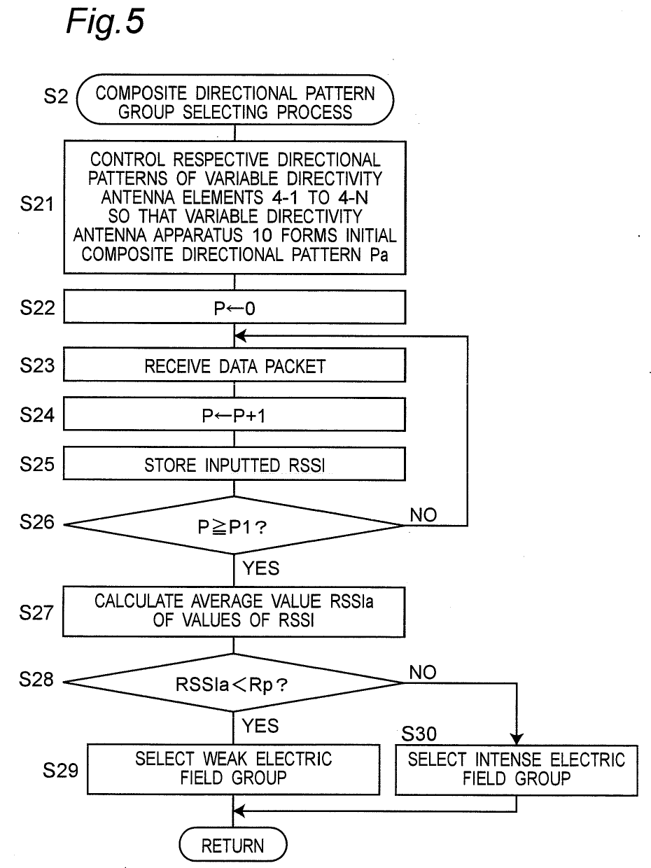

FIG. 1 is a block diagram showing a configuration of a wireless communication apparatus 1 according to the first preferred embodiment of the present invention. In the present preferred embodiment, a composite directional pattern table memory 2m stores therein composite directional pattern classification information of a variable directivity antenna apparatus 10 in a form of a table including the composite directional pattern classification information. FIG. 2 is a chart showing one example of a composite directional pattern table stored in the composite directional pattern table memory 2m of FIG. 1. In addition, FIG. 3 is a chart showing one example of composite directional patterns Pa to Pf of the composite directional pattern table of FIG. 2. Further, FIG. 4 is a flow chart showing a directional pattern control process executed by a controller 2 of FIG. 1, and FIG. 5 to FIG. 7 are flow charts showing a composite directional pattern group selecting process S2 of FIG. 4, a composite directional pattern selecting process S4 of FIG. 4, and a reference RSSI (RSSIr) calculating process S7 of FIG. 4, respectively. It is noted that the configuration of the wireless communication apparatus 1 of FIG. 1 is applied to the following preferred embodiments and modified preferred embodiments.

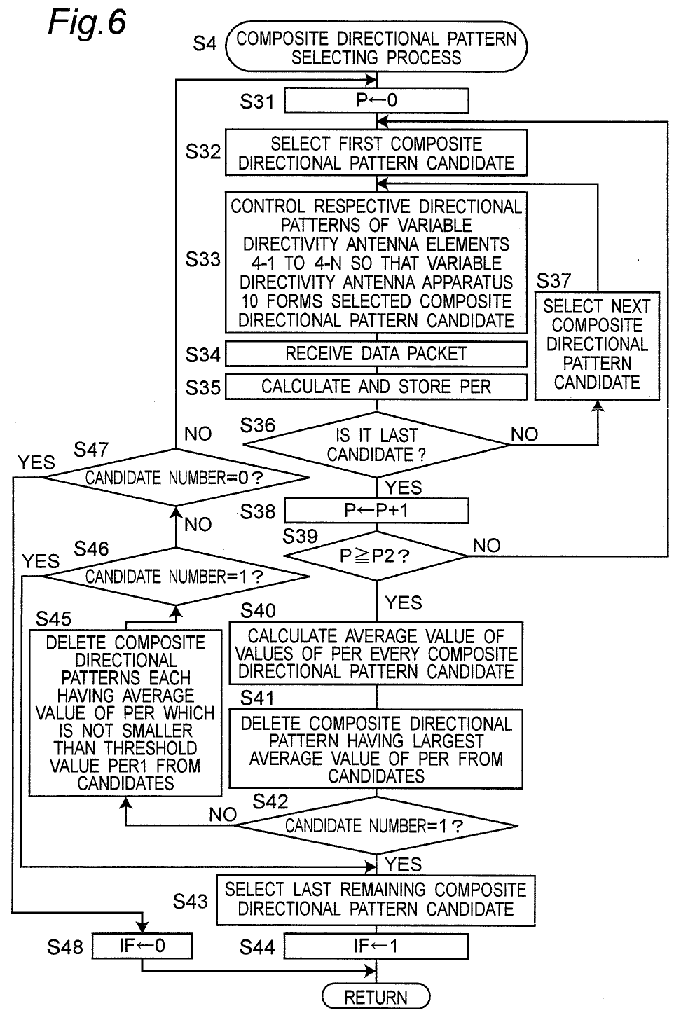

In this case, as described later in detail, the wireless communication apparatus 1 includes the variable directivity antenna apparatus 10, the controller 2, and the composite directional pattern table memory 2m. The variable directivity antenna apparatus 10 includes a plurality of N variable directivity antenna elements 4-1 to 4-N, and forms a plurality of composite directional patterns each of which is a superposition of respective directional patterns of the variable directivity antenna elements 4-1 to 4-N. The controller 2 controls the composite directional pattern of the variable directivity antenna apparatus 10 based on an Received Signal Strength Indicator (referred to as an RSSI hereinafter), which is a first parameter representing a received signal level of a wireless signal received by the variable directivity antenna apparatus 10, and a Packet Error Rate (referred to as a PER hereinafter), which is a second parameter representing a quality level of the wireless signal. The composite directional pattern table memory 2m previously stores therein the composite directional pattern table including the composite directional pattern classification information. For each of the composite directional patterns, the composite directional pattern classification information includes data on the directional patterns of the respective variable directivity antenna elements 4-1 to 4-N and data on a directional pattern group which is selected from among a plurality of composite directional pattern groups set by using the RSSI and in which the composite directional pattern is included. The controller 2 is characterized by executing the following processes. First of all, the controller 2 measures the RSSI by controlling the variable directivity antenna apparatus 10 to form the composite directional pattern Pa among the plurality of composite directional patterns (step S21 of FIG. 5). Next, the controller 2 selects one composite directional pattern group from among the plurality of composite directional pattern groups with reference to the composite directional pattern table based on a measured RSSI (the composite directional pattern group selecting process of FIG. 5). Then, when the controller 2 controls the variable directivity antenna apparatus 10 to form composite directional patterns included in a selected composite directional pattern group, the controller 2 measures the PER for the composite directional patterns included in the selected composite directional pattern group, respectively, and selects one composite directional pattern from among the composite directional patterns included in the selected composite directional pattern group based on respective measured values of PER (the composite directional pattern selecting process of FIG. 6). Finally, the controller 2 controls the variable directivity antenna apparatus 10 to form a selected composite directional pattern (step S6 of FIG. 4).

In addition, the controller 2 is characterized by measuring the PER when the controller 2 controls the variable directivity antenna apparatus 10 to form the selected composite directional pattern, judging whether or not a measured PER is smaller than a predetermined threshold value PER2 (step S12 of FIG. 4), and controlling the variable directivity antenna apparatus 10 to form a further composite directional pattern other than the selected composite directional pattern upon detecting that the measured PER is equal to or larger than the predetermined threshold PER2.

Further, the controller 2 is characterized by controlling the variable directivity antenna apparatus 10 to form the further composite directional pattern other than the selected composite directional pattern upon detecting that the measured PER is equal to or larger than the predetermined threshold PER2 a predetermined threshold times Pec, successively (if YES at step S14 of FIG. 4).

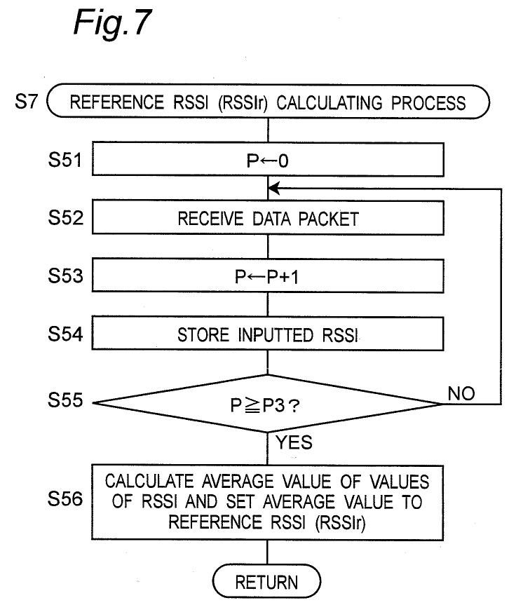

Still further, the controller 2 is characterized by measuring RSSI when the controller 2 controls the variable directivity antenna apparatus 10 to form the selected composite directional pattern, calculating a reference RSSI (RSSIr) based on the RSSI measured immediately after the start of the control (reference RSSI (RSSIr) calculating process of FIG. 7), and calculating the average value RSSIb of the last values of RSSI based on the values of RSSI measured immediately before the detection. In addition the controller 2 selects the above-mentioned further composite directional pattern from among all of the composite directional patterns when the magnitude of a difference between the reference RSSI (RSSIr) and the RSSIb is equal to or larger than a predetermined threshold value ΔRc (if YES at step S16 of FIG. 4). The controller 2 selects the above-mentioned further composite directional pattern from among the composite directional patterns that are included in the selected composite directional pattern group and other than the selected composite directional pattern when the magnitude of the difference between the reference RSSI (RSSIr) and the RSSIb is smaller than the predetermined threshold value ΔRc (NO at step S16 of FIG. 4).

First of all, the configuration and operation of the wireless communication apparatus 1 are described. Referring to FIG. 1, the wireless communication apparatus 1 of the MIMO transmission system wirelessly receives data signals such as audio and visual data transmitted in a form of packets from another wireless communication apparatus via the variable directivity antenna apparatus 10. In this case, the wireless communication apparatus 1 is configured by including the variable directivity antenna apparatus 10, a plurality of N high-frequency processing circuits 5-1, 5-2, . . . , 5-N, a baseband processing circuit 6, a MAC (Media Access Control) processing circuit 7, the controller 2 for controlling the operation of the apparatus 10 and the circuits 5-1, 5-2, . . . , 5-N, 6, and 7, and the composite directional pattern table memory 2m for previously storing therein the plurality of composite directional patterns Pa to Pf of the variable directivity antenna apparatus 10.

Referring to FIG. 1, the variable directivity antenna apparatuses 10 is configured by including the plurality of N variable directivity antenna elements 4-1, 4-2, . . . , 4-N, and a plurality of N directivity controllers 3-1, 3-2, . . . , 3-N connected to the variable directivity antenna elements 4-1, 4-2, . . . , 4-N, respectively. The directivity controllers 3-1 to 3-N include reactance elements connected to the variable directivity antenna elements 4-1, 4-2, . . . , 4-N, respectively. The directivity controllers 3-1 to 3-N control the directional patterns of the variable directivity antenna elements 4-1 to 4-N by changing electrical lengths of the variable directivity antenna elements 4-1 to 4-N by changing reactances of the reactance elements based on control signals from the controller 2, respectively. Wireless signals received by the variable directivity antenna elements 4-1, 4-2, . . . , 4-N are inputted to the high-frequency processing circuits 5-1, 5-2, . . . , 5-N, respectively. In the present specification, it is noted that a directional pattern, which is a superposition of the respective directional patterns of the variable directivity antenna elements 4-1, 4-2, . . . , 4-N, is referred to as the composite directional pattern of the variable directivity antenna apparatus 10.

In addition, referring to FIG. 1, each of the high-frequency processing circuits 5-1, 5-2, . . . , 5-N includes a high-frequency bandpass filter for performing a predetermined bandpass processing on an inputted wireless signal, a low-noise amplifier for amplifying the wireless signal after the bandpass processing, a direct conversion system demodulator for demodulating the wireless signal after the amplification directly into a baseband signal, and a baseband filter for performing a predetermined bandpass processing on the baseband signal. Each of the high-frequency processing circuits 5-1, 5-2, . . . , 5-N outputs the baseband signal after the bandpass processing to the controller 2 and the baseband processing circuit 6.

Further, referring to FIG. 1, the baseband processing circuit 6 includes a plurality of N AGC (Automatic Gain Control) circuits for controlling so that signal levels of the baseband signals inputted from the high-frequency processing circuits 5-1, 5-2, . . . , 5-N become substantially constant, and a MIMO decoding circuit for generating a decoded signal by performing the MIMO decoding process on the baseband signals from the AGC circuit and outputting the decoded signal to the MAC processing circuit 7. In this case, at the time of receiving a data packet, the baseband processing circuit 6 calculates the values of RSSI for the respective baseband signals based on respective AGC voltages, that are control voltages outputted from the AGC circuits, calculates an average value of the values of RSSI, and outputs the average value to the controller 2. Further, at the time of receiving a data packet, the baseband processing circuit 6 calculates total transmitting signal power to noise ratios (referred to as values of signal to noise ratios (SNR) hereinafter) for the baseband signals, calculates an average value of the values of SNR, and outputs the average value to the controller 2. In addition, based on the data packet included in the decoded signal, the MAC processing circuit 7 judges whether or not the data packet is directed to the wireless communication apparatus 1.

When the data packet is directed to the wireless communication apparatus 1, the MAC processing circuit 7 performs the predetermined MAC processing on the decoded signal from the baseband processing circuit 6, and outputs the decoded signal as an output signal from the wireless communication apparatus 1. Further, upon receiving the first data packet, the MAC processing circuit 7 outputs a packet communication start notification signal for notification of the start of packet receiving to the controller 2. On the other hand, upon receiving the last data packet, the MAC processing circuit 7 outputs a packet communication end notification signal for notification of the end of packet receiving to the controller 2.

The controller 2 calculates the PER by using a predetermined conversion formula between the SNR and the PER based on the SNR from the baseband processing circuit 6. In addition, the controller 2 selects one composite directional pattern from among the composite directional patterns Pa to Pf by executing the directional pattern control process described later in detail with reference to FIG. 4 to FIG. 7. Further, the controller 2 controls the respective directional patterns of the variable directivity antenna elements 4-1 to 4-N by using the directivity controllers 3-1 to 3-N so that the variable directivity antenna apparatus 10 forms the selected composite directional pattern.

Next, with reference to FIG. 2 and FIG. 3, there is described the composite directional pattern table previously stored in the composite directional pattern table memory 2m of the controller 2 when N is three. Referring to FIG. 2, the composite directional pattern table memory 2m stores therein the composite directional pattern table representing relations between the composite directional patterns Pa to Pf of the variable directivity antenna apparatus 10 and two composite directional pattern groups (an intense electric field group and a weak electric field group) classified according to the RSSI. In this case, each of the composite directional patterns Pa to Pf includes the directional patterns of the variable directivity antenna elements 4-1 to 4-3. In addition, the composite directional pattern table memory 2m stores data on the control signals outputted from the controller 2 to the directivity controllers 3-1 to 3-3 for the respective directional patterns of the variable directivity antenna elements 4-1 to 4-3.

As shown in FIG. 2, the composite directional pattern Pa is an initial composite directional pattern described later in detail, and is included in the weak electric field group. In the case of the composite directional pattern Pa, the variable directivity antenna elements 4-1 to 4-3 form directional patterns Pa1 to Pa3, respectively. In addition, the composite directional pattern Pb is included in the intense electric field group and the weak electric field group, and the variable directivity antenna elements 4-1 to 4-3 form directional patterns Pb1 to Pb3, respectively. Further, the composite directional pattern Pc is included in the intense electric field group and the weak electric field group, and the variable directivity antenna elements 4-1 to 4-3 form directional patterns Pc1 to Pc3, respectively. Still further, the composite directional pattern Pd is included in the intense electric field group, and the variable directivity antenna elements 4-1 to 4-3 form directional patterns Pd1 to Pd3, respectively. In addition, the composite directional pattern Pe is included in the intense electric field group, and the variable directivity antenna elements 4-1 to 4-3 form directional patterns Pe1 to Pe3, respectively. Further, the composite directional pattern Pf is included in the intense electric field group, and the variable directivity antenna elements 4-1 to 4-3 form directional patterns Pf1 to Pf3, respectively.

Next, with reference to FIG. 3, concrete examples of the composite directional patterns Pa to Pf are described. As shown in FIG. 3, in the case of the initial composite directional pattern Pa, the directional antenna elements 4-1 to 4-3 have the substantially omnidirectional directional patterns Pa1 to Pa3, respectively. In the case of the composite directional pattern Pb, the variable directivity antenna element 4-1 forms the directional pattern Pb 1 having a beam width of about 90 degrees and a beam azimuth angle of about 220 degrees, the variable directivity antenna element 4-2 forms the directional pattern Pb2 having a beam width of about 90 degrees and a beam azimuth angle of about 100 degrees, and the variable directivity antenna element 4-3 forms the directional pattern Pb3 having a beam width of about 90 degrees and a beam azimuth angle of about 340 degrees. In addition, in the case of the composite directional pattern Pc, the variable directivity antenna element 4-1 forms the directional pattern Pc1 having a beam width of about 90 degrees and a beam azimuth angle of about 230 degrees, the variable directivity antenna element 4-2 forms the directional pattern Pc2 having a beam width of about 90 degrees and a beam azimuth angle of about 130 degrees, and the variable directivity antenna element 4-3 forms the directional pattern Pc3 having a beam width of about 120 degrees and a beam azimuth angle of about 0 degrees. Further, regarding the composite directional pattern Pd, the variable directivity antenna element 4-1 forms the directional pattern Pd1 having a beam width of about 70 degrees and a beam azimuth angle of about 225 degrees, the variable directivity antenna element 4-2 forms the directional pattern Pd2 having a beam width of about 70 degrees and a beam azimuth angle of about 135 degrees, and the variable directivity antenna element 4-3 forms the directional pattern Pd3 having a beam width of about 70 degrees and a beam azimuth angle of about 0 degrees. Still further, regarding the composite directional pattern Pe, the variable directivity antenna element 4-1 forms the directional pattern Pe1 having a beam width of about 70 degrees and a beam azimuth angle of about 215 degrees, the variable directivity antenna element 4-2 forms the directional pattern Pe2 having a beam width of about 70 degrees and a beam azimuth angle of about 115 degrees, and the variable directivity antenna element 4-3 forms the directional pattern Pe3 having a beam width of about 70 degrees and a beam azimuth angle of about 340 degrees. In addition, in the case of the composite directional pattern Pf, the variable directivity antenna element 4-1 forms the directional pattern Pf1 having a beam width of about 70 degrees and a beam azimuth angle of about 250 degrees, the variable directivity antenna element 4-2 forms the directional pattern Pf2 having a beam width of about 70 degrees and a beam azimuth angle of about 140 degrees, and the variable directivity antenna element 4-3 forms the directional pattern Pf3 having a beam width of about 70 degrees and a beam azimuth angle of about 20 degrees.

Namely, as shown in FIG. 3, the composite directional pattern Pa is substantially omnidirectional. In addition, in the cases of the composite directional patterns Pb and Pc, the beam widths of the directional patterns Pb1 to Pb3 and Pc1 to Pc3 of the variable directivity antenna elements 4-1 to 4-3 are almost the same as each other. Further, in the cases of the composite directional patterns Pd, Pe and Pf, the beam widths of the directional patterns Pd 1 to Pd3, Pe1 to Pe3 and Pf1 to Pf3 of the variable directivity antenna elements 4-1 to 4-3 are almost the same as each other, and narrower than the beam widths of the directional patterns Pb1 to Pb3 and Pc1 to Pc3 of the variable directivity antenna elements 4-1 to 4-3 for the composite directional patterns Pb and Pc. Namely, the composite directional patterns Pd to Pf have directivity higher than that of the composite directional patterns Pb and Pc.

Next, with reference to FIG. 4 to FIG. 7, the directional pattern control process executed by the controller 2 is described. First of all, the controller 2 controls the directional patterns of the variable directivity antenna elements 4-1 to 4-N so that the variable directivity antenna apparatus 10 forms the composite directional pattern Pa in a reception-standby state when no data packet is received.

Next, it is judged whether or not the packet communication start notification signal has been received from the MAC processing circuit 7 at step S1 of the directional pattern control process of FIG. 4. If YES at step S1, the control flow goes to the composite directional pattern group selecting process of step S2, and if NO at step S1, the control flow returns to step S1.

At step S21 of the composite directional pattern group selecting process of FIG. 5, the respective directional patterns of the variable directivity antenna elements 4-1 to 4-N are controlled so that the variable directivity antenna apparatus 10 forms the initial composite directional pattern Pa, which is closest to an omnidirectional directivity pattern among the composite directional patterns Pa to Pf. Then, zero is substituted into a packet number P at step S22, a data packet is received at step S23, and thereafter, one is added to the packet number P at step S24. Next, the RSSI inputted from the baseband processing circuit 6 is stored at step S25, and the control flow goes to step S26. At step S26, it is judged whether or not the packet number P is equal to or larger than a predetermined packet number P1. If NO at step S26, the control flow returns to step S23, and if YES at step S26, the control flow goes to step S27. At step S27, The average value RSSIa of stored P1 values of RSSI is calculated, and it is judged at step S28 whether or not a calculated average value RSSIa is smaller than a predetermined threshold value Rp. If YES at step S28, the control flow goes to step S29 to select the weak electric field group in the composite directional pattern table memory 2m, and returns to the directional pattern control process of FIG. 4. If NO at step S28, the control flow goes to step S30 to select the intense electric field group in the composite directional pattern table memory 2m, and returns to the directional pattern control process of FIG. 4.

The control flow returns to the directional pattern control process of FIG. 4, and goes to step S3. In the first candidate setting process of step S3, all of the composite directional patterns included in the composite directional pattern group selected by the composite directional pattern group selecting process are set to composite directional pattern candidates with reference to the composite directional pattern table, and the control flow goes to the composite directional pattern selecting process of step S4.

At step S31 of the composite directional pattern selecting process of FIG. 6, zero is substituted into the packet number P. Then, at step S32, a first candidate is selected from among the composite directional pattern candidates, and at step S33, the respective directional patterns of the variable directivity antenna elements 4-1 to 4-N are controlled so that the variable directivity antenna apparatus 10 forms the selected composite directional pattern candidate. Then, the control flow goes to step S34. Next, a data packet is received at step S34, and the PER is calculated based on the SNR inputted from the baseband processing circuit 6, and the PER is stored at step S35. Further, at step S36, it is judged whether or not the currently selected composite directional pattern is the last composite directional pattern candidate. If NO at step S36, the control flow goes to step S37 to select a next composite directional pattern candidate, and returns to step S33. If YES at step S36, one is added to the packet number P at step S38, and thereafter, at step S39, it is judged whether or not the packet number P is equal to or larger than a predetermined packet number P2. If NO at step S39, the control flow returns to step S32, and if YES at step S39, the control flow goes to step S40.

At step S40 of FIG. 6, an average value of the stored P2 values of PER is calculated every composite directional pattern candidates based on the stored values of PER. Then, the composite directional pattern having the largest calculated average value of PER is deleted from the composite directional pattern candidates at step S41, and the control flow goes to step S42. At step S42, it is judged whether or not the number of the currently remaining composite directional pattern candidates is one. If YES at step S42, the control flow goes to step S43, and if NO at step S42, the control flow goes to S45. Then, at step S43, the last remaining composite directional pattern candidate is selected, and at step S44, one is substituted into a flag IF representing whether or not the composite directional pattern has been able to be selected. Then, the control flow returns to the directional pattern control process of FIG. 4.

On the other hand, at step S45, the composite directional pattern candidate each having calculated average value of PER which is equal to or larger than a predetermined threshold value PER1 is deleted from the candidates, and at step S46, it is judged whether or not the number of the currently remaining composite directional pattern candidate is one. If YES at step S46, the control flow goes to step S43, and if NO at step S46, the control flow goes to S47. Further, at step S47, it is judged whether or not the number of the currently remaining composite directional pattern candidates is zero. If NO at step S47, the control flow returns to step S31, and if YES at step S47, the control flow goes to step S48. At step S48, zero is substituted into the flag IF, and the control flow returns to the directional pattern control process of FIG. 4.

The control flow returns to the directional pattern control process of FIG. 4, and goes to step S5 to judge whether or not the flag IF is one (namely, whether or not the composite directional pattern has been able to be selected). If NO at step S5, the control flow returns to the composite directional pattern group selecting process of step S2, and if YES at step S5, the control flow goes to step S6.

In this case, referring to FIG. 4, a process including the processes of steps S6 to S14 described later is a receiving processes in a steady state to perform packet communications when the variable directivity antenna apparatus 10 is controlled to form the selected composite directional pattern by the composite directional pattern selecting process.

At step S6 of FIG. 4, the respective directional patterns of the variable directivity antenna elements 4-1 to 4-N are controlled so that the variable directivity antenna apparatus 10 forms the selected composite directional pattern, and the control flow goes to the reference RSSI (RSSIr) calculating process of step S7.

At step S51 of the reference RSSI (RSSIr) calculating process of FIG. 7, zero is substituted into the packet number P, and after the data packet is received at step S52, one is added to the packet number P at step S53. Then, after the RSSI inputted from the baseband processing circuit 6 is stored at step S54, the control flow goes to step S55. At step S55, it is judged whether or not the packet number P is equal to or larger than a predetermined packet number P3. If NO at step S55, the control flow returns to step S52, and if YES at step S55, the control flow goes to step S56. An average value of the stored P3 values of RSSI is calculated as the reference RSSI (RSSIr) at step S56, and the control flow returns to the directional pattern control process of FIG. 4.

The control flow returns to the directional pattern control process of FIG. 4, and the reference RSSI (RSSIr) calculating process is ended at step S7. Thereafter, zero is substituted into a packet number Pe, and the data packet is received at step S9. Next, at step S10, the RSSI inputted from the baseband processing circuit 6 is stored and the PER is calculated based on the SNR inputted from the baseband processing circuit 6, and the control flow goes to step S11. At step S11, it is judged whether or not the packet communication end notification signal has been received from the MAC processing circuit 7. If YES ate step S11, the control flow returns to step S1, and if NO at step S11, the control flow goes to step S12. At step S12, it is judged whether or not the last PER is smaller than a predetermined threshold value PER2. If YES at step S12, the control flow returns to step S8, and if NO at step S12, the control flow goes to step S13. Then, one is added to the packet number Pe at step S13, and the control flow goes to step S14. At step S14, it is judged whether or not the packet number Pe is equal to or larger than a predetermined threshold value Pec. If NO at step S14, the control flow returns to step S9, and if YES at step S14, the control flow goes to step S15. Namely, when the signal quality level of the wireless signal has deteriorated due to changes in the radio wave propagation environment or the like and the PER has become equal to or larger than the predetermined threshold value PER2 the predetermined packet number Pec successively, the receiving process in the steady state is ended, and the control flow goes to step S15.

At step S15 of FIG. 4, an average value RSSIb of the values of RSSI for the last Pec packets is calculated, and the control flow goes to step S16. Then, at step S16, it is judged whether or not the magnitude of a difference between the average value RSSIb of the values of RSSI and the reference RSSIr in the steady state is equal to or larger than a predetermined threshold value ΔRc. If YES at step S16, the control flow returns to step S2, and if NO at step S16, the control flow goes to step S17. In a second candidate setting process of step S17, composite directional patterns other than the selected composite directional pattern and included in the currently selected composite directional pattern group is set to composite directional pattern candidates with reference to the composite directional pattern table, and the control flow returns to step S4.

Namely, referring to FIG. 4, first of all, the controller 2 selects the intense electric field group or the weak electric field group based on the RSSI representing the signal level of the wireless signal by the composite directional pattern group selecting process (step S2). Next, the controller 2 selects one composite directional pattern from among the composite directional patterns included in the selected composite directional pattern group based on the PER representing the signal quality level of the wireless signal by the composite directional pattern selecting process (step S4), and the control flow goes to the receiving process in the steady state (steps S4 to S14). In the steady state, when the controller 2 controls the respective directional patterns of the variable directivity antenna elements 4-1 to 4-N so that the variable directivity antenna apparatus 10 forms the selected composite directional pattern (step S6), the controller 2 calculates the reference RSSI (RSSIr) in the steady state by the reference RSSI (RSSIr) calculating process (step S7). Then, based on the change in the PER with time, when the controller 2 has detected (step S14) that the signal quality level of the wireless signal has deteriorated by variations in the radio wave propagation environment or the like as compared with the signal quality level detected when the receiving process in the steady state is started (step S6), the receiving process in the steady state is ended. Subsequently, the controller 2 judges whether or not the magnitude of the difference between the reference RSSI (RSSIr) in the steady state and the average value RSSIr of the last values of RSSI is equal to or larger than the predetermined threshold value ΔRc (step S16). In this case, when an instantaneous minute change in the radio wave propagation environment such as a change in the radio wave propagation environment when a person intersects the radio wave propagation path has occurred, the magnitude of the difference between the average value RSSIb of the last values of RSSI and the reference RSSI (RSSIr) becomes smaller than the predetermined threshold value ΔRc, and the controller 2 selects the other composite directional pattern from among the composite directional patterns other than the selected composite directional pattern and included in the currently selected composite directional pattern group by the composite directional pattern selecting process (steps S17, S4 and S5). On the other hand, when the radio wave propagation environment has changed relatively largely, the magnitude of the difference between the average value RSSIb of the last values of RSSI and the reference RSSI (RSSIr) becomes equal to or larger than the predetermined threshold value ΔRc, and the controller 2 selects the other composite directional pattern from among all of the composite directional patterns Pa to Pf stored in the composite directional pattern table memory 2m (steps S2 to S5).

The control of the directional pattern of the variable directivity antenna apparatus 10 at each of step S6 of FIG. 4, step S21 of FIG. 5, and step S33 of FIG. 6 is performed at a timing when a time period required for changing the composite directional pattern of the variable directivity antenna apparatus 10 during packet communications can be secured. For example, the composite directional pattern of the variable directivity antenna apparatus 10 may be changed within a time period from a timing when the wireless communication apparatus 1 transmits a packet including an acknowledgement signal of a received data packet to a wireless communication apparatus of a transmitter side to a timing when a next data packet is received.

Next, one example of the directional pattern control process by the controller 2 when N is three is described. For example, when the average value RSSIa of the values of RSSI is smaller than the predetermined threshold value Rp at step S28 of the composite directional pattern group selecting process of FIG. 5, the weak electric field group is selected at step S29. Then, at step S3 (the first candidate setting process) of FIG. 4, the composite directional patterns Pa to Pc included in the weak electric field group are set to the composite directional pattern candidates. Next, in the composite directional pattern selecting process of FIG. 6, while changing the composite directional pattern among the composite directional patterns Pa, Pb and Pc every one packet, the values of PER are stored by the predetermined packet number P2 for each of the composite directional patterns. Next, the average value of the stored P2 values of PER is calculated for each of the composite directional patterns Pa, Pb and Pc. In this case, for example, when the average value of the values of PER for the composite directional pattern Pc is largest, the composite directional pattern Pc is deleted from the composite directional pattern candidates. Further, when the average values of the PER for the remaining composite directional pattern candidates Pa and Pb are smaller than the predetermined threshold value PER1, while changing the composite directional pattern between the composite directional patterns Pa and Pb every one packet, the values of PER are stored by the predetermined packet number P2 for each of the composite directional patterns. Then, the average value of the stored P2 values of PER is calculated for each of the composite directional patterns Pa and Pb. In this case, when the average value of the PER for the composite directional pattern Pa is larger than the average value of the PER for the composite directional pattern Pb, the composite directional pattern Pb is selected, and the composite directional pattern selecting process is ended.

Next, in the receiving process in the steady state of FIG. 4, when the controller 2 controls the respective directional patterns of the variable directivity antenna elements 4-1 to 4-N so that the variable directivity antenna apparatus 10 forms the composite directional pattern Pb, the controller 2 calculates the reference RSSI (RSSIr). When the signal quality level of the wireless signal has deteriorated due to changes in the radio wave propagation environment or the like and the PER becomes smaller than the predetermined threshold value PER2 the predetermined packet number Pec successively, the receiving process in the steady state is ended. In this case, when the magnitude of the difference between the reference RSSI (RSSIr) and the average value RSSIb of the values of RSSI in the last Pec data packets is smaller than the predetermined threshold value ΔRc, the composite directional patterns Pa and Pc other than the currently selected composite directional pattern Pb and included in the weak electric field group are set to the composite directional pattern candidates. Further, the composite directional pattern is reselected from among the composite directional pattern candidates Pa and Pc by the composite directional pattern selecting process.

According to the wireless communication apparatus 1 of the present preferred embodiment, in the receiving process in the steady state when the variable directivity antenna apparatus 10 is controlled to form the selected composite directional pattern in the composite directional pattern selecting process, it is judged whether or not the quality level of the wireless received signal has deteriorated below a predetermined level based on the PER, which is the signal quality level of the wireless received signal at the time of receiving the data packet. Therefore, differently from the antenna directivity control system described in the Patent Document 1, it is not required to perform the measurement signal transceiving and antenna control for detecting changes in the radio wave propagation environment in the steady state, and therefore, it is possible to prevent the deterioration in the throughput from occurring. Further, since the control is performed so that the composite directional pattern of the variable directivity antenna apparatus 10 is changed only when the quality level of the wireless received signal has deteriorated to a predetermined level, it is not required to perform the antenna control for detecting changes in the radio wave propagation environment to be different from the antenna selecting diversity apparatus described in the Patent Document 2, and therefore, it is possible to prevent the deterioration in the throughput from occurring. Therefore, according to the wireless communication apparatus 1 of the present preferred embodiment, the data signal can be transmitted and received at higher speed and more stably than in the prior art even when the radio wave propagation environment changes.

In addition, according to the wireless communication apparatus 1 of the present preferred embodiment, when the magnitude of the difference between the reference RSSI (RSSIr) and the last RSSI is equal to or larger than the predetermined threshold value ΔRc, the controller 2 selects a further composite directional pattern by executing the composite directional pattern group selecting process (step S2), the first candidate setting process (step S3), and the composite directional pattern selecting process (step S4). In addition, when the magnitude of the difference is smaller than the predetermined threshold value ΔRc, the controller 2 selects the further composite directional pattern by executing the second candidate setting process (step S17) and the composite directional pattern selecting process (step S4). Therefore, since the composite directional pattern group selecting process is not executed when the magnitude of the difference is smaller than the predetermined threshold value ΔRc, time required for selecting an composite directional pattern, which is optimum in the current radio wave propagation environment, can be shortened than that for the prior arts, and changes in the radio wave propagation environment can be followed more rapidly.

Further, according to the present preferred embodiment, since the plurality of directional patterns can be achieved by one variable directivity antenna element, the size of the wireless communication apparatus of the MIMO transmission system can be reduced than those of the prior arts.

### First Modified Preferred Embodiment of First Preferred Embodiment

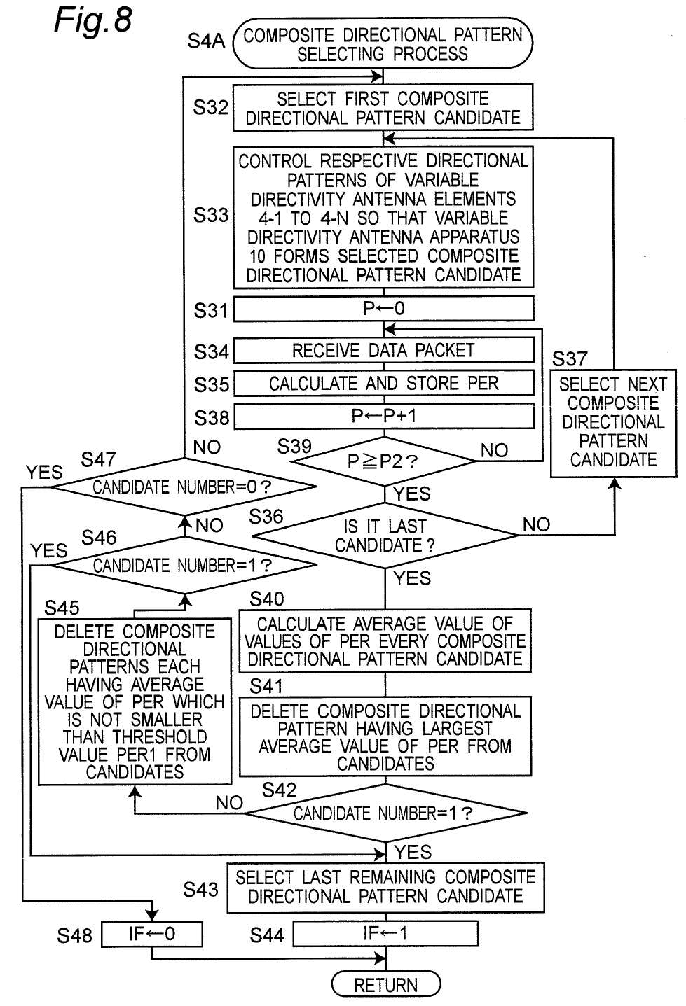

FIG. 8 is a flow chart showing a composite directional pattern selecting process S4a according to the first modified preferred embodiment of the first preferred embodiment of the present invention. As compared with the first preferred embodiment, the process of the first modified preferred embodiment is obtained by replacing the composite directional pattern selecting process S4 (FIG. 6) executed by the controller 2 of FIG. 1 with the composite directional pattern selecting process S4A.

Referring to FIG. 8, first of all, a first candidate is selected from among the composite directional pattern candidates at step S32, and at step S33, the respective directional patterns of the variable directivity antenna elements 4-1 to 4-N are controlled so that the variable directivity antenna apparatus 10 forms the selected composite directional pattern candidate. Next, zero is substituted into the packet number P at step S31. Then, a data packet is received at step S34, and the PER is calculated based on the SNR inputted from the baseband processing circuit 6 and stored at step S35. Further, one is added to the packet number P at step S38, and it is judged at step S39 whether or not the packet number P is equal to or larger than the predetermined packet number P2. If NO at step S39, the control flow returns to step S34, and if YES at step S39, the control flow goes to step S36. At step S36, it is judged whether or not the currently selected composite directional pattern is the last composite directional pattern candidate. If NO at step S36, the control flow goes to step S37 to select the next composite directional pattern candidate, and returns to step S33. If YES at step S36, the control flow goes to step S40. Then, processes the same as those of steps S40 to S47 of the directional pattern control process of FIG. 4 are executed following to the process of step S40.

The first modified preferred embodiment exhibits advantageous effects similar to those of the first preferred embodiment described above.

### Second Modified Preferred Embodiment of First Preferred Embodiment

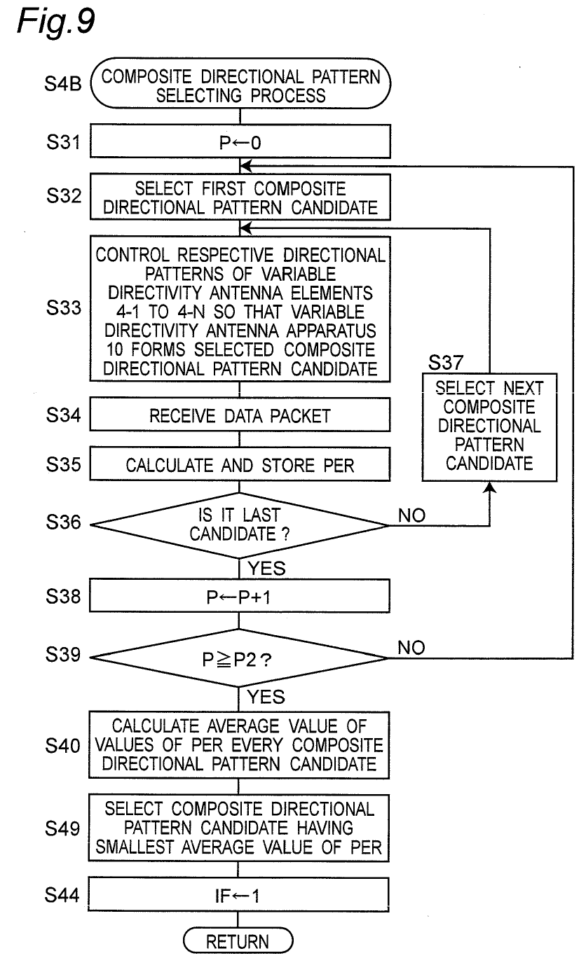

FIG. 9 is a flow chart showing a composite directional pattern selecting process S4B according to the second modified preferred embodiment of the first preferred embodiment of the present invention. As compared with the first preferred embodiment, the process of the second modified preferred embodiment is obtained by replacing the composite directional pattern selecting process S4 (FIG. 6) executed by the controller 2 of FIG. 1 with the composite directional pattern selecting process S4B.

Referring to FIG. 9, first of all, the processes of steps S31 to S40 are performed in a manner similar to that of the composite directional pattern selecting process S4 of FIG. 6. Then, subsequent to step S40, a composite directional pattern candidate having the smallest average value of the PER is selected at step S49, one is substituted into the flag IF representing whether or not the composite directional pattern has been able to be selected at step S44, and the control flow returns to the directional pattern control process of FIG. 4.

In the composite directional pattern selecting process S4B of the second modified preferred embodiment, steps S41 to S48 of the composite directional pattern selecting process S4 of the first preferred embodiment are replaced with steps S44 and S49. Therefore, the composite directional pattern candidate can be selected rapidly and reliably. Further, since the composite directional pattern candidate can surely be selected, the judgment process at step S5 of FIG. 4 can be eliminated.

### Third Modified Preferred Embodiment of First Preferred Embodiment

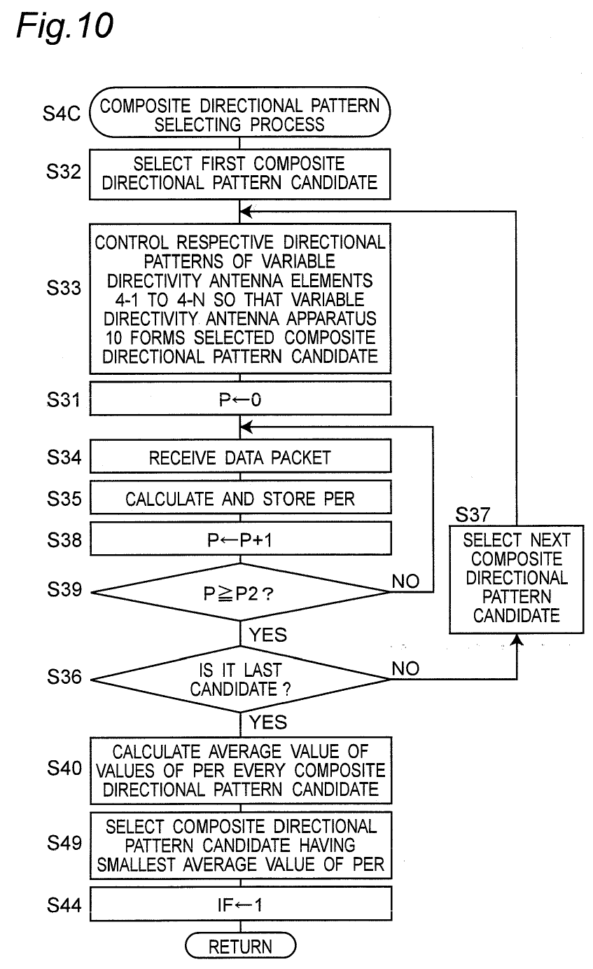

FIG. 10 is a flow chart showing a composite directional pattern selecting process S4C according to the third modified preferred embodiment of the first preferred embodiment of the present invention. As compared with the second modified embodiment, the process of the third modified preferred embodiment is obtained by replacing the composite directional pattern selecting process S4B (FIG. 9) executed by the controller 2 of FIG. 1 with the composite directional pattern selecting process S4C.

Referring to FIG. 10, first of all, a first candidate is selected from among the composite directional pattern candidates at step S32 in a manner similar to that of the composite directional pattern selecting process S4A (FIG. 8) of the first modified preferred embodiment, and the respective directional patterns of the variable directivity antenna elements 4-1 to 4-N are controlled so that the variable directivity antenna apparatus 10 forms the selected composite directional pattern candidate. Next, at step S31, zero is substituted into the packet number P. Then, a data packet is received at step S34, and the PER is calculated based on the SNR inputted from the baseband processing circuit 6 and stored at step S35. Further, one is added to the packet number P at step S38, and at step S39, it is judged whether or not the packet number P is equal to or larger than the predetermined packet number P2. If NO at step S39, the control flow returns to step S34, and if YES at step S39, the control flow goes to step S36. At step S36, it is judged whether or not the currently selected composite directional pattern is the last composite directional pattern candidate. If NO at step S36, the control flow goes to step S37 to select the next composite directional pattern candidate, and returns to step S33. If YES at step S36, the control flow goes to step S40. At step S40, the average value of the stored P2 values of PER is calculated every composite directional pattern candidates based on the stored values of PER.

Then, subsequent to step S40, in a manner similar to that of the composite directional pattern selecting process S4B (FIG. 9) of the second modified preferred embodiment, a composite directional pattern candidate having the smallest average value of the PER is selected at step S49. Then, at step S44, one is substituted into the flag IF representing whether or not the composite directional pattern has been able to be selected, and the control flow returns to the directional pattern control process of FIG. 4.

The third modified preferred embodiment exhibits advantageous effects similar to those of the second modified preferred embodiment.

### Second Preferred Embodiment

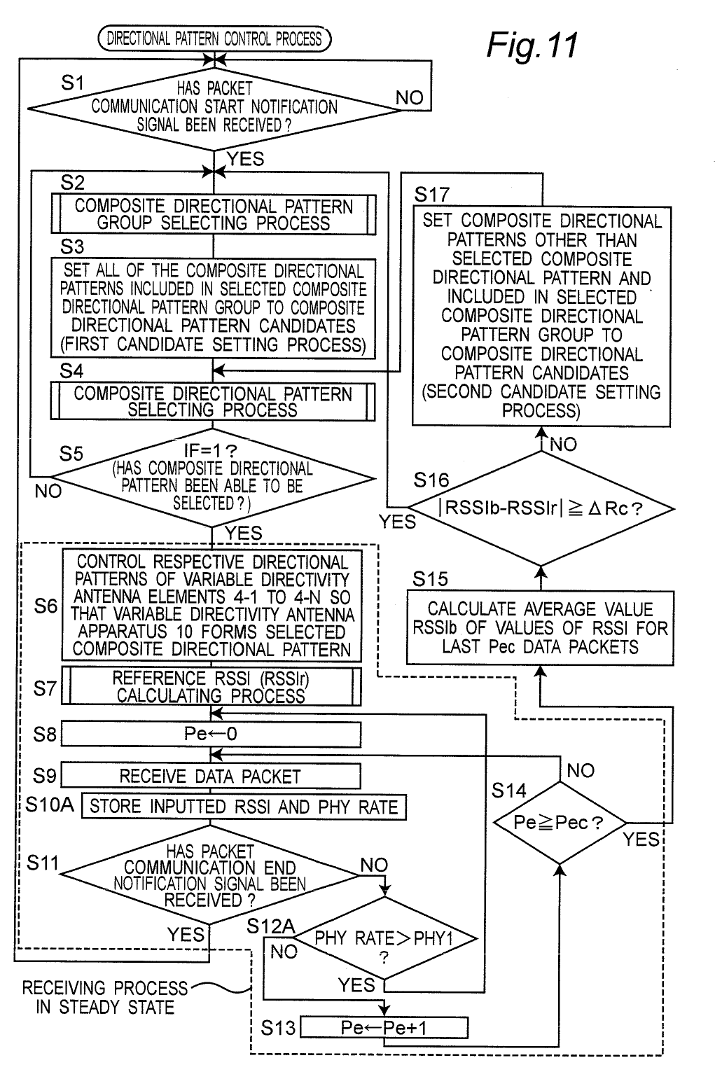

FIG. 11 is a flow chart showing a directional pattern control process according to the second preferred embodiment of the present invention. As compared with the directional pattern control process (See FIG. 4) of the first preferred embodiment, the directional pattern control process of the present preferred embodiment is characterized in that a PHY rate of a third parameter which represents the quality level of the wireless signal received by the variable directivity antenna apparatus 10 is measured in stead of the PER of the second parameter during the receiving process in the steady state. Concretely speaking, the composite directional pattern selecting process of FIG. 11 is obtained by replacing the processes of steps S10 and S12 of the composite directional pattern processing of FIG. 4 with processes of step S10A and step S12A, respectively.

In the present preferred embodiment, the baseband processing circuit 6 calculates physical transmitting rates (referred to as PHY rates hereinafter) of the packet for the baseband signals, respectively, at the time of receiving a data packet, calculates an average value of the PHY rates, and outputs the average value to the controller 2. For example, in a wireless LAN system of IEEE802.11 system standardized by IEEE (The Institute of Electrical and Electronics Engineers Inc.), a terminal that transmits a packet determines the PHY rate of the packet according to the past transmitting circumstances and transmits the packet. In this case, a terminal that receives the packet needs the PHY rate of the packet, namely, the information of the modulation system and the encoding rate in order to correctly demodulate a received signal. Therefore, the terminal that transmits the packet adds information of the PHY rate of the packet into a “SIGNAL” field that exists in the head part of the packet, so as to allow the receiving terminal to demodulate the packet. The baseband processing circuit 6 calculates the PHY rate for each baseband signal by processing the “SIGNAL” field of the received packet signal. The controller 2 stores the RSSI and the PHY rate inputted from the baseband processing circuit 6 at step S10A. Then, it is judged at step S12A whether or not the last PHY rate is larger than a predetermined threshold value PHY 1.

The present preferred embodiment exhibits advantageous effects similar to those of the first preferred embodiment.

### First Modified Preferred Embodiment of Second Preferred Embodiment

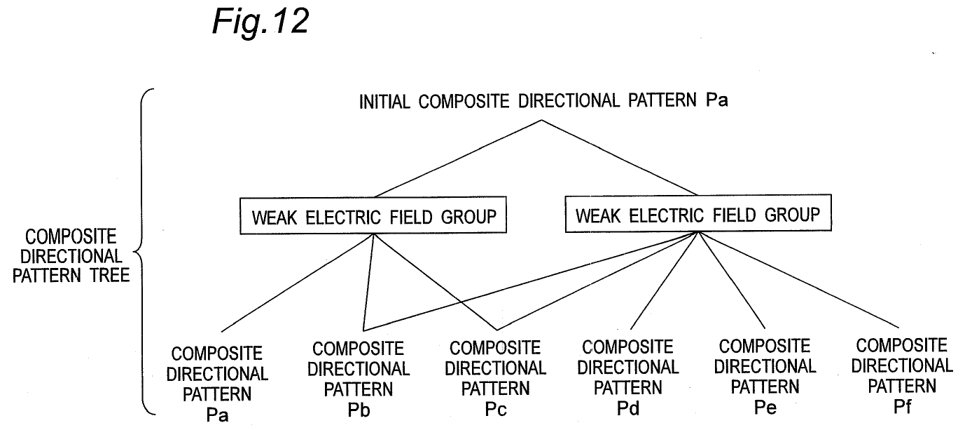

FIG. 12 is a conceptual diagram showing the composite directional pattern classification information stored in the composite directional pattern table memory 2m in the first modified preferred embodiment of the second preferred embodiment of the present invention. In the first and second preferred embodiments, the composite directional pattern table memory 2m stores therein the composite directional pattern classification information of the variable directivity antenna apparatus 10 in a form of a table including the composite directional pattern classification information. In the present modified preferred embodiment, as shown in FIG. 12, the composite directional pattern table memory 2m stores therein the composite directional pattern classification information of the variable directivity antenna apparatus 10 in a form of a tree of three hierarchies including the composite directional pattern classification information. The present modified preferred embodiment exhibits advantageous effects similar to those of the first preferred embodiment and the second preferred embodiment.

### Third Preferred Embodiment

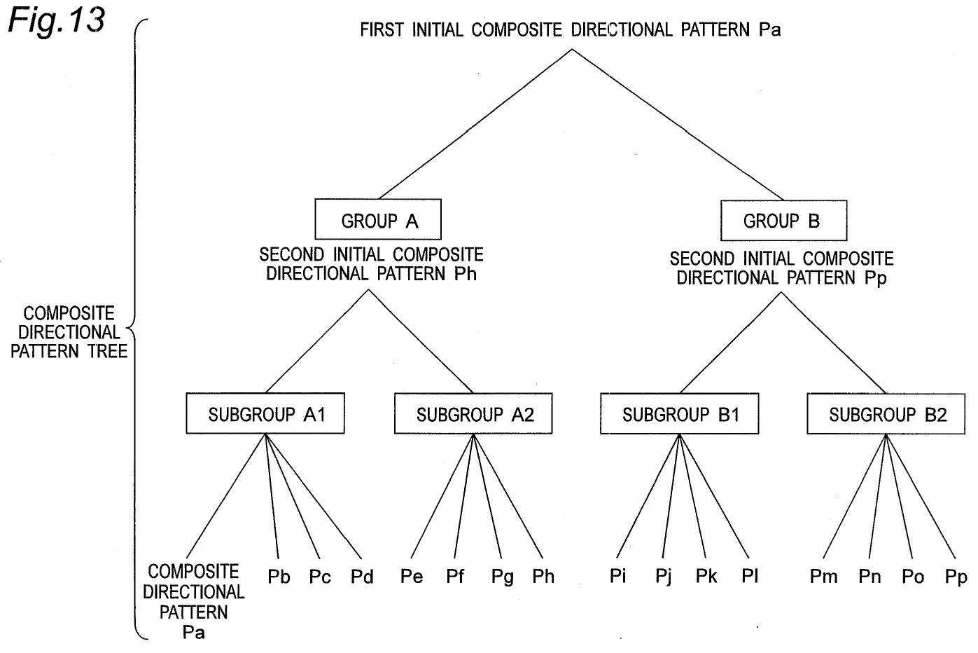

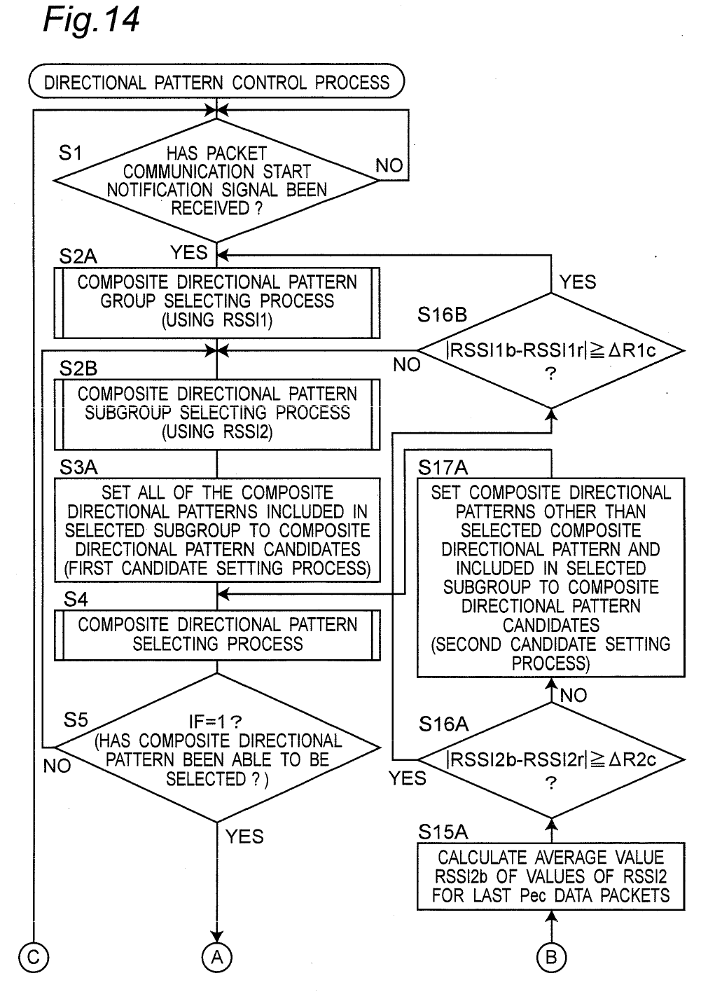

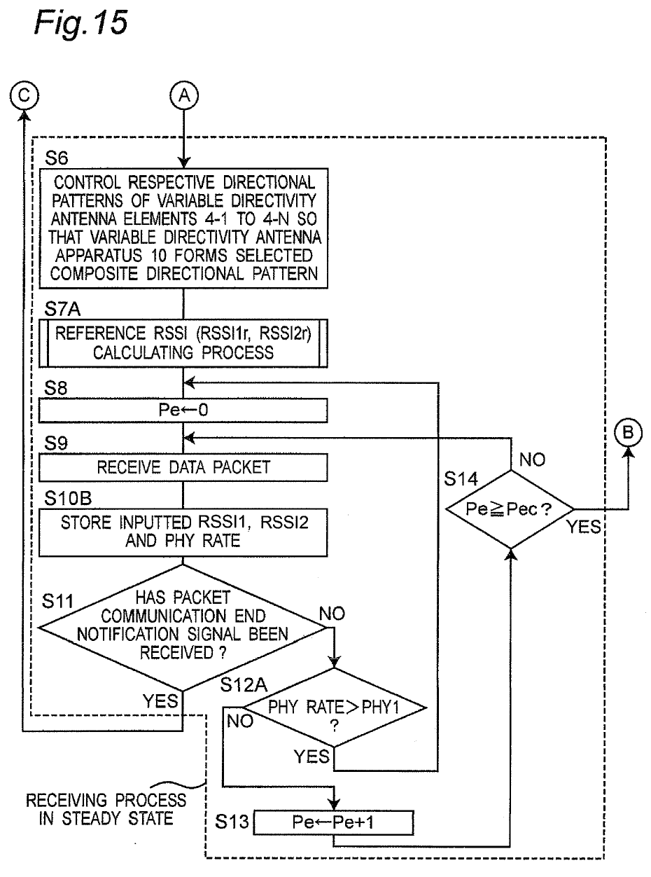

FIG. 13 is a conceptual diagram showing the composite directional pattern classification information stored in the composite directional pattern table memory 2m in the third preferred embodiment of the present invention. FIG. 14 and FIG. 15 are flow charts showing a directional pattern control process according to the third preferred embodiment of the present invention. The present preferred embodiment is characterized in that the composite directional pattern classification information of the variable directivity antenna apparatus 10 in a form of a tree of four hierarchies including the composite directional pattern classification information, as compared with the second preferred embodiment.

As shown in FIG. 13, the composite directional pattern table memory 2m stores therein the composite directional pattern classification information of the variable directivity antenna apparatus 10 in a form of the tree of four hierarchies including the composite directional pattern classification information. Referring to FIG. 13, the composite directional patterns Pa to Pp are classified into a group A including the composite directional patterns Pa to Ph, and a group B including the composite directional patterns Pi to Pp. In addition, the composite directional patterns Pa to Ph included in the group A are classified into a subgroup A1 including the composite directional patterns Pa to Pd and a subgroup A2 including the composite directional patterns Pe to Ph. Further, the composite directional patterns Pi to Pp included in the group B are classified into a subgroup B1 including the composite directional patterns Pi to P1 and a subgroup B2 including the composite directional patterns Pm to Pp. In this case, the composite directional pattern Pa is the first initial composite directional pattern, and the composite directional patterns Ph and Pp are second initial composite directional patterns.

In the present preferred embodiment, at the time of receiving a data packet, the baseband processing circuit 6 calculates an RSSI1 for the baseband signal of the wireless signal received by using the variable directivity antenna element 4-1, and an RSSI2 for the baseband signal of the wireless signal received by using the variable directivity antenna element 4-2, based on the respective AGC voltages, that are control voltages outputted from the AGC circuits, and outputs the RSSI1 and RSSI2 to the controller 2.

At step S1 of FIG. 14, it is judged whether or not the packet communication start notification signal has been received from the MAC processing circuit 7. If YES at step S1, the control flow goes to the composite directional pattern group selecting process of step S2A, and if NO at step S1, the control flow returns to step S1.

The composite directional pattern group selecting process of step S2A is obtained by replacing the “initial composite directional pattern Pa” at step S21 with the “first initial composite directional pattern Pa”, replacing “RSSI” at step S27 with “RSSI1”, replacing the “weak electric field group” at step S29 with the “group A” and replacing the “intense electric field group” at step S30 with the “group B”, in the composite directional pattern group selecting process of FIG. 5. Namely, the group A or the group B is selected based on the RSSI1 by the composite directional pattern group selecting process.

Next, the composite directional pattern subgroup selecting process at step S2B is executed. In the composite directional pattern subgroup selecting process, a subgroup in the group selected at step S2A is selected based on RSSI2 in a manner similar to that of the composite directional pattern group selecting process at step S2A. For example, when the group A is selected at step S2A, the subgroup A1 or A2 is selected based on the RSSI2 by using the second initial composite directional pattern Ph. When the group B is selected at step S2A, the subgroup B1 or B2 is selected based on the RSSI2 by using the second initial composite directional pattern Pp.

Next, in a first candidate setting process at step S3A, all of the composite directional patterns included in the subgroup selected by the composite directional pattern subgroup selecting process are set to composite directional pattern candidates with reference to the composite directional pattern table memory 2m, and the control flow goes to the composite directional pattern selecting process of step S4. In the composite directional pattern selecting process of step S4, one composite directional pattern is selected or not selected from among the composite directional pattern candidates in a manner similar to that of the first and second preferred embodiments.

Subsequently to step S4, it is judged at step S5 whether or not the flag IF is one (namely, whether or not the composite directional pattern has been able to be selected). If NO at step S5, the control flow returns to the composite directional pattern subgroup selecting process of step S2B, and if YES at step S5, the control flow goes to step S6.

At step S6, the respective directional patterns of the variable directivity antenna elements 4-1 to 4-N are controlled so that the variable directivity antenna apparatus 10 forms the selected composite directional pattern, and the control flow goes to a reference RSSI (RSSI1r, RSSI2r) calculating process of step S7A. At step S7A, in a manner similar to that of the reference RSSI (RSSIr) calculating process of FIG. 7, a reference RSSI (RSSI1r) and a reference RSSI (RSSI2r) are calculated. In this case, the reference RSSI (RSSI1r) is an average value of the values of RSSI1 of immediately preceding P3 packets, and the reference RSSI (RSSI2r) is an average value of the values of RSSI2 of immediately preceding P3 packets.

Subsequently, zero is substituted into the packet number Pe at step S8, and a data packet is received at step S9. Next, at step S10B, the RSSI1, the RSSI2 and the PHY rate inputted from the baseband processing circuit 6 are stored, and the control flow goes to step S11. At step S11, It is judged whether or not the packet communication end notification signal has been received from the MAC processing circuit 7. If YES at step S11, the control flow returns to step S1, and if NO at step S11, the control flow goes to step S12A. At step S12A, it is judged whether or not the last PHY rate is larger than the predetermined threshold value PHY1. If YES at step S12A, the control flow returns to step S8, and if NO at step S12A, the control flow goes to step S13. Then, one is added to the packet number Pe at step S13, and the control flow goes to step S14. At step S14, it is judged whether or not the packet number Pe is equal to or larger than the predetermined threshold value Pec. If NO at step S14, the control flow returns to step S9, and if YES at step S14, the control flow goes to step S15A.

At step S15A, an average value RSSI2b of values of RSSI2 for the last Pec packets is calculated, and the control flow goes to step S16A. Then, at step S16A, it is judged whether or not a magnitude of a difference between the average value RSSI2b of the values of RSSI2 and the reference RSSI2r in the steady state is equal to or larger than a predetermined threshold value ΔR2c. If YES at step S16A, the control flow goes to step S16B9, and if NO at step S16A, the control flow goes to step S17A. In the second candidate setting process of step S17A, composite directional patterns other than the selected composite directional pattern and included in the currently selected subgroup are set to composite directional pattern candidates with reference to the composite directional pattern table memory 2m, and the control flow returns to step S4.

At step S16B, an average value RSSI1b of the values of RSSI1 of the last Pec packets is calculated, and it is judged whether or not a magnitude of a difference between a calculated average value RSSI1b and the reference RSSI1r in the steady state is equal to or larger than a predetermined threshold value ΔR1c. If YES at step S16B, the control flow returns to step S2A, and if NO at step S16B, the control flow returns to step S2B.

According to the present preferred embodiment, a composite directional pattern can be selected efficiently from among the greater number of composite directional patterns Pa to Pp as compared with the second preferred embodiment. Although the composite directional pattern classification information of the variable directivity antenna apparatus 10 is stored in a form of the tree of four hierarchies including the composite directional pattern classification information in the present preferred embodiment, the present invention is not limited to this. It is acceptable to store the information in a form of a tree of a plurality more than five hierarchies.

In each of the preferred embodiments and the modified preferred embodiments described above, the predetermined threshold value Pec of the packet number at step S14 of FIG. 4, FIG. 11 and FIG. 15, the predetermined packet number P1 at step S26 of FIG. 5, the predetermined packet number P2 at step S39 of FIG. 6 and FIG. 8 to FIG. 10, and the predetermined packet number P3 at step S55 of FIG. 7 are each set to, for example, a packet number corresponding to a time period required for properly calculating the average value of the RSSI. Preferably, the predetermined threshold value Pec of the packet number at step S14 of FIG. 4, FIG. 11 and FIG. 15, and the predetermined packet number P3 at step S55 of FIG. 7 have values the same as each other. In addition, the predetermined threshold value PER2 of the PER at step S12 of FIG. 4, the threshold value PHY1 of the PHY rate at step S12A of FIG. 11 and FIG. 15, and the predetermined threshold value PER1 of the PER at step S45 of FIG. 6 and FIG. 8 are each set, for example, based on a predetermined wireless communication quality such as a maximum value of the PER required by a predetermined wireless communication standard.

In addition, in each of the preferred embodiments and the modified preferred embodiments, the step S14 of FIG. 4, FIG. 11 and FIG. 15 may be replaced with a step of judging whether or not an elapsed time from the end of step S7 is equal to or larger than a time (referred to as a time Trssi hereinafter) required for properly calculating the average value of the RSSI. Step S26 of FIG. 5 may be replaced with a step of judging whether or not an elapsed time from the end of step S21 is equal to or larger than the Trssi. Step S39 of FIG. 6 and FIGS. 8 to 10 may be replaced with a step of judging whether or not an elapsed time from the start of the composite directional pattern selecting process is equal to or larger than the Trssi. Step S55 of FIG. 7 may be replaced with a step of judging whether or not an elapsed time from the start of the reference RSSI (RSSIr) calculating process is equal to or larger than the Trssi. In this case, the wireless communication apparatus further includes a timer circuit for measuring the elapsed time.

In addition, in each of the preferred embodiments and the modified preferred embodiments, the predetermined threshold value Rp of the RSSI used for determining which of the weak electric field group and the intense electric field group (See FIG. 2 and FIG. 3) is to be selected at step S28 of FIG. 5, and the predetermined threshold value ΔRc at step S16 of FIG. 4 and FIG. 11 are set based on each RSSI required for obtaining predetermined wireless communication quality (for example, a predetermined PER) when, for example, the variable directivity antenna apparatus 10 is controlled to form each of the composite each directional patterns Pa to Pf. For example, the predetermined threshold value Rp of the RSSI used for determining which of the weak electric field group and the intense electric field group is to be selected (See FIG. 3) may be set to an RSSI for obtaining the predetermined PER when the variable directivity antenna apparatus 10 is controlled to form the composite directional pattern Pb. The predetermined threshold value ΔRc at step S16 of FIG. 4 and FIG. 11, the predetermined threshold value ΔR2c at step S16A of FIG. 14 and the predetermined threshold value ΔR1c at step S16B of FIG. 14 may be set to a value of a difference between the RSSI required for obtaining the predetermined PER when the variable directivity antenna apparatus 10 is controlled to form the composite directional pattern Pb and an RSSI required for obtaining the predetermined PER when the variable directivity antenna apparatus 10 is controlled to form the composite directional pattern Pa.

Still further, in each of the preferred embodiments and the modified preferred embodiments, the composite directional pattern table memory 2m stores therein the composite directional patterns of two composite directional pattern groups, however, the present invention is not limited to this. The composite directional pattern table memory 2m may store therein composite directional patterns of a plurality of three or more composite directional pattern groups.

In addition, in each of the preferred embodiments and the modified preferred embodiments, the MAC processing circuit 7 generates the packet communication start notification signal and the packet communication end notification signal, and outputs the same signals to the controller 2, however, the present invention is not limited to this. For example, the high-frequency processing circuits 5-1 to 5-N, the baseband processing circuit 6 or a higher-order protocol processing circuit (not shown) may generate the packet communication start notification signal and the packet communication end notification signal, and output the same signals to the controller 2.

Further, in each of the preferred embodiments and the modified preferred embodiments, the baseband processing circuit 6 calculates the RSSI and outputs the same RSSI to the controller 2, however, the present invention is not limited to this. For example, each of the high-frequency processing circuits 5-1 to 5-N may calculate the RSSI based on a power level of the baseband signal, and thereafter, output the same RSSI to the controller 2. In this case, the controller 2 may calculate an average value of inputted values of RSSI, and use the same average value for the directional pattern control processes of FIG. 4 and FIG. 11.

Still further, the controller 2, the composite directional pattern table memory 2m, and the directivity controllers 3-1 to 3-N may be realized by hardware or software. In addition, the configuration of the variable directivity antenna apparatus 10 is not limited to that of each of the preferred embodiments, but the variable directivity antenna apparatus 10 is required to have a configuration capable of changing the composite directional pattern. For example, the variable directivity antenna apparatus 10 may include only one variable directivity antenna element.

In each of the preferred embodiments and the modified preferred embodiments, the directivity controllers 3-1 to 3-N include reactance elements connected to the variable directivity antenna elements 4-1 to 4-N, respectively. The directivity controllers 3-1 to 3-N control the directional patterns of the variable directivity antenna elements 4-1 to 4-N, respectively, by changing the reactances of the reactance elements based on the control signals from the controller 2 so as to change the electrical lengths of the respective variable directivity antenna elements 4-1 to 4-N, respectively. However, the present invention is not limited to this. Each of the variable directivity antenna elements 4-1 to 4-N may have a feeding antenna element and a passive antenna element, and each of the directivity controllers 3-1 to 3-N may include a PIN diode connected to the passive antenna element of each of the variable directivity antenna elements 4-1 to 4-N. The directivity controllers 3-1 to 3-N may control the directional patterns of the variable directivity antenna elements 4-1 to 4-N by applying predetermined bias voltages to the PIN diodes according to control signals from the controller 2 so as to operate the passive elements connected to the PIN diodes as reflectors, respectively.

In addition, in the composite directional pattern group selecting process of FIG. 5, the RSSI is measured when the respective directional patterns of the variable directivity antenna elements 4-1 to 4-N of the variable directivity antenna apparatus 10 are controlled so that the apparatus has the initial composite directional pattern Pa, which is closest to the omnidirectional directional pattern among the composite directional patterns Pa to Pf, and either one of the weak electric field group and the intense electric field group is selected based on the measured RSSI. However, the present invention is not limited to this. A substantially omnidirectional directional pattern appropriate for the measurement of the RSSI may be used instead of the initial composite directional pattern Pa. In addition, a further substantially omnidirectional composite directional pattern, which is not included in the composite directional pattern table, may be used instead of the initial composite directional pattern Pa.

Further, in each of the preferred embodiments and the modified preferred embodiments, one group is selected from the weak electric field group and the intense electric field group by performing the composite directional pattern group selecting process (See FIG. 5) using the first parameter. Then, one composite directional pattern is selected from among the composite directional patterns included in the selected group by performing the composite directional pattern selecting process (See FIG. 6, FIG. 8, FIG. 9 and FIG. 10) using the second parameter. Further, in the receiving process (See FIG. 4 and FIG. 11) in the steady state, it is detected that the quality level of the wireless signal has deteriorated below the predetermined quality level using the third parameter. In this case, in the first preferred embodiment, the first, second and third parameters are the RSSI, the PER and the PER, respectively. In the second preferred embodiment, the first, second and third parameters are the RSSI, the PER and the PHY rate, respectively. However, the present invention is not limited to this. It is required that the first to third parameters represent the quality level of the wireless signal received by the variable directivity antenna apparatus 10, and that the first parameter and the second parameter are different from each other. In addition, the second parameter and the third parameter may be the same as or different from each other. For example, the first to third parameters may be selected, so that the first and second parameters are different from each other, from among values representing the signal level of the wireless signal received by the variable directivity antenna apparatus 10 and values representing the signal quality levels of the wireless signal received by the variable directivity antenna apparatus 10. For example, the values representing the signal level of the wireless signal received by the variable directivity antenna apparatus 10 include an average value of the respective AGC voltages that is the control voltages outputted from the respective AGC circuits in the baseband processing circuit 6. The values representing the signal quality levels of the wireless signal received by the variable directivity antenna apparatus 10 include the SNR, a Bit Error Rate (BER), a Symbol Error Rate (SER), and an interchannel correlation, an interantenna correlation, or eigenvalues of a correlation matrix used in the MIMO communication system.

Still further, in the each of the preferred embodiments and the modified preferred embodiments, the interantenna correlation (also referred to as the interchannel correlation) used in the MIMO communication system representing the quality level of the wireless signal received by the variable directivity antenna apparatus 10 may be used instead of the RSSI of the first parameter representing the signal level of the wireless signal. In this case, the second parameter representing the quality level of the wireless signal is the PER. In addition, for each of the composite directional patterns of the variable directivity antenna apparatus 10, the composite directional pattern table includes data on the directional patterns of the respective variable directivity antenna elements 4-1 to 4-N and data on the directional pattern group which is selected from among a plurality of composite directional pattern groups and in which the composite directional pattern is included, where the plurality of composite directional pattern group are set using the first parameter. In this case, the plurality of composite directional pattern groups include a first composite directional pattern group including a predetermined composite directional pattern for measuring the first parameter, a second composite directional pattern group including a composite directional pattern having a directivity smaller than that of the predetermined composite directional pattern, and a third composite directional pattern group including a composite directional pattern having a directivity larger than that of the predetermined composite directional pattern. Further, in the composite directional pattern group selecting process, the controller 2 measures the interantenna correlation when the controller 2 controls the variable directivity antenna apparatus 10 to have the predetermined composite directional pattern. Then, the controller 2 performs control to reduce the interantenna correlation by selecting the second composite directional pattern group when the measured first parameter is larger than a predetermined threshold value, and controls to secure a larger receiving power by selecting the third composite directional pattern group when the measured first parameter is equal to or smaller than the predetermined threshold value.

In addition, in the second preferred embodiment, the composite directional pattern selecting process of step S4 may be replaced with the composite directional pattern selecting process of the first to third modified preferred embodiments of the first preferred embodiment.

Further, in the first preferred embodiment, for each of the composite directional patterns, the composite directional pattern table memory 2m previously stores therein the composite directional pattern classification information, which is the data on the respective composite directional patterns of the variable directivity antenna elements 4-1 to 4-N and the data on the directional pattern group which is selected from among the plurality of composite directional pattern groups (the intense electric field group and the weak electric field group) and in which the composite directional pattern is included, where the plurality of composite directional pattern groups are set using the RSSI. However, the present invention is not limited to this. The composite directional pattern table memory 2m is required to previously store therein composite directional pattern classification information on classification of the plurality of composite directional patterns into a plurality of composite directional pattern groups set by using a first parameter representing the quality level of the wireless signal received by the variable directivity antenna apparatus 10.

### INDUSTRIAL APPLICABILITY

As described above in detail, the wireless communication apparatus according to the present invention has the storage device and the controller. The storage device previously stores composite directional pattern classification information on classification of the plurality of composite directional patterns into a plurality of composite directional pattern groups set by using a first parameter representing a quality level of a wireless signal received by the variable directivity antenna apparatus. The controller selects one composite directional pattern from among the plurality of composite directional patterns based on the first parameter and a second parameter, and controls the composite directional pattern of the variable directivity antenna apparatus so that the variable directivity antenna apparatus forms a selected composite directional pattern, where the second parameter represents the quality level of the wireless signal and is different from the first parameter. Therefore, even when the radio wave propagation environment changes, the data signal can be transmitted and received at higher speed and more stably than in the prior art.

For example, the wireless communication apparatus according to the present invention can be utilized for wireless communication equipment and the like for transferring data signals having large volumes such as AV stream data by utilizing the MIMO transmission system.

### REFERENCE SIGNS LIST

1 . . . wireless communication apparatus,
2 . . . controller,
2m . . . composite directional pattern table memory,
3-1, 3-2, . . . , 3-N . . . directivity controller,
4-1, 4-2, . . . , 4-N . . . variable directivity antenna element,
5-1, 5-2, . . . , 5-N . . . high-frequency processing circuit,
6 . . . baseband processing circuit,
7 . . . MAC processing circuit, and
10 . . . variable directivity antenna apparatus.

1-9. (canceled)

10. A wireless communication apparatus comprising:
a variable directivity antenna apparatus comprising at least one variable directivity antenna element, and forming a plurality of composite directional patterns each of which is a superposition of respective directional patterns of the at least one variable directivity antenna element;
a storage device for previously storing therein composite directional pattern classification information on classification of the plurality of composite directional patterns into a plurality of composite directional pattern groups set by using a first parameter representing a quality level of a wireless signal received by the variable directivity antenna apparatus; and
a controller for selecting one composite directional pattern from among the plurality of composite directional patterns based on the first parameter and a second parameter, and for controlling the composite directional pattern of the variable directivity antenna apparatus so that the variable directivity antenna apparatus forms a selected composite directional pattern, the second parameter representing the quality level of the wireless signal and being different from the first parameter.

11. The wireless communication apparatus as claimed in claim 10,
wherein (a) when the controller controls the variable directivity antenna apparatus to form one predetermined composite directional pattern among the plurality of composite directional patterns, the controller measures the first parameter, and selects one composite directional pattern group from among the plurality of composite directional pattern groups with reference to the composite directional pattern classification information based on a measured first parameter,
wherein (b) when the controller controls the variable directivity antenna apparatus to form composite directional patterns included in a selected composite directional pattern group, the controller measures second parameters for the composite directional patterns included in the selected composite directional pattern group, respectively, and selects one composite directional pattern from among the composite directional patterns included in the selected composite directional pattern group based on respective measured second parameters; and
wherein (c) the controller controls the variable directivity antenna apparatus to form a selected composite directional pattern.

12. The wireless communication apparatus as claimed in claim 11,
wherein the controller measures a third parameter representing the quality level of the wireless signal when the controller controls the variable directivity antenna apparatus to form the selected composite directional pattern, judges whether or not a measured third parameter is equal to or smaller than a predetermined first threshold value, and controls the variable directivity antenna apparatus to form a further composite directional pattern other than the selected composite directional pattern upon detecting that the measured third parameter is equal to or smaller than the first threshold value.

13. The wireless communication apparatus as claimed in claim 12,
wherein the controller controls the variable directivity antenna apparatus to form the further composite directional pattern other than the selected composite directional pattern upon detecting that the measured third parameter is equal to or smaller than the first threshold value a predetermined threshold times successively.

14. The wireless communication apparatus as claimed in claim 13,
wherein the controller measures the first parameter when the controller controls the variable directivity antenna apparatus to form the selected composite directional pattern,
calculates a reference first parameter based on the first parameter measured immediately after starting the control,
calculates a last first parameter based on the first parameter measured immediately before the detection,
selects the further composite directional pattern from among all of the plurality of composite directional patterns when a magnitude of a difference between a calculated reference first parameter and the last first parameter is equal to or larger than a predetermined second threshold value, and
selects the further composite directional pattern from among the composite directional patterns other than the selected composite directional patter and included in the selected composite directional pattern group when the magnitude of the difference between the calculated reference first parameter and the last first parameter is smaller than the predetermined second threshold value.

15. The wireless communication apparatus as claimed in claim 11,
wherein the third parameter is the same as the second parameter.

16. The wireless communication apparatus as claimed in claim 11,
wherein the predetermined one composite directional pattern is substantially omnidirectional.

17. The wireless communication apparatus as claimed in claim 10,
wherein the first parameter represents a received signal level of the wireless signal.

18. The wireless communication apparatus as claimed in claim 10,
wherein, for each of the composite directional patterns, the composite directional pattern classification information includes data on the directional patterns of the respective variable directivity antenna elements and data on the directional pattern group which is selected from among the plurality of composite directional pattern groups and in which the composite directional pattern is included.
